(19) United States
(12) Patent Application Publication
(10) Pub. No.: US 2020/0045952 A1
(43) Pub. Date: Feb. 13, 2020

(54) AGRICULTURAL SPRAY SYSTEM WINDSCREEN

(71) Applicant: PROGRESSIVE GROWER TECHNOLOGIES, INC., Mount Angel, OR (US)

(72) Inventor: William J. Hartman, Wilsonville, OR (US)

(73) Assignee: PROGRESSIVE GROWER TECHNOLOGIES, INC., Mount Angel, OR (US)

(21) Appl. No.: 16/059,831

(22) Filed: Aug. 9, 2018

(51) Int. Cl. A01M 7/00

(52) U.S. Cl. CPC A01M 7/0064; A01M 7/0042

(57) ABSTRACT

Examples described herein include a transportable agricultural spray system that may comprise a transportable sprayer with one or more spray nozzles to emit one or more fluid sprays while transported through air in a first direction. A first air-permeable panel may be positioned adjacent the transportable sprayer substantially outside the one or more fluid sprays to extend over an area transverse to the first direction across the one or more fluid sprays. In some examples, the first air-permeable panel may be positioned in the first direction in relation to the one or more fluid sprays. Other examples may include a second air-permeable panel positioned adjacent the transportable sprayer at least substantially outside the one or more fluid sprays to extend over and an area across the one or more fluid sprays transverse to the first direction, wherein the second air-permeable panel is positioned opposite the first direction in relation to the one or more fluid sprays.

### BACKGROUND OF THE INVENTION

Agricultural spray systems are sometimes transported by a vehicle through agricultural fields to apply agricultural liquids, such as pesticides, to crops. Such spray systems emit multiple fluid sprays in respective primary spray directions (e.g., downward) while the vehicle carries spray system in a transport direction (e.g., horizontally across a field). As the vehicle moves in the transport direction, the fluid sprays may be subject at least to a transverse air flow that may be generally opposite the transport direction. In addition, environmental conditions, such as wind, may come from any direction relative to transport direction and may contribute to the transverse air flow.

An aspect of the fluid sprays is that they may include numerous lightweight droplets and/or particulates that may be caused to deviate or drift from the primary spray directions by the transverse air flow. Drift of the fluid sprays from the primary spray directions may decrease the efficiency and/or completeness with which the fluid sprays cover or are applied to crops. As a consequence, the effectiveness of the fluid sprays may be decreased, or increased amounts of the fluid sprays may need to be applied to compensate for decreased efficiency and/or completeness of coverage resulting from misdirection of the fluid sprays caused by the transverse airflow.

### SUMMARY OF THE INVENTION

Examples described herein include a transportable agricultural spray system that may comprise a transportable sprayer with one or more spray nozzles to emit one or more fluid sprays while transported through air in a first direction. A first air-permeable panel or windscreen may be positioned adjacent the transportable sprayer substantially outside the one or more fluid sprays to extend over an area transverse to the first direction across the one or more fluid sprays. In some examples, the first air-permeable panel may be positioned in the first direction in relation to the one or more fluid sprays. Other examples may include a second air-permeable panel or windscreen positioned adjacent the transportable sprayer at least substantially outside the one or more fluid sprays to extend over and an area across the one or more fluid sprays transverse to the first direction, wherein the second air-permeable panel is positioned opposite the first direction in relation to the one or more fluid sprays. Transportable spray systems with first and/or second air-permeable panels, as described herein, may reduce or minimize deviation or drifting of fluid sprays that may otherwise arise due to transverse air flow that may be caused when such systems are operated while being transported through air. Transportable spray systems with first and/or second air-permeable panels, as described herein, may allow such systems to be transported through agricultural fields at higher speeds, while maintaining minimized deviation or drifting of fluid sprays, to increase the efficiency and reduce the cost of applying agricultural fluid sprays.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a schematic illustration of an example of a prior art transportable agricultural spray system.

FIG. 2 is a schematic illustration of an example of a transportable spray system that may be carried on and/or transported by a vehicle in accordance with embodiments described herein.

FIG. 3 is a partial front view of a first example of an air-permeable panel or windscreen that may be employed in the a transportable spray system of FIG. 2

FIG. 4 is a partial front view of a second example of an air-permeable panel or windscreen that may be employed in the a transportable spray system of FIG. 2

FIG. 5 is a partial front view of a third example of an air-permeable panel or windscreen that may be employed in the a transportable spray system of FIG. 2

FIG. 6 is a rear perspective view of another example of a transportable spray system that may analogous to the transportable spray system of FIG. 2.

FIG. 7 is a side view of the example of a transportable spray system of FIG. 6.

FIG. 8 is a block diagram of a panel orientation adjustment system.

FIG. 9 is a flow diagram of a method of varying an orientation of at least one air-permeable panel of a transportable spray system.

FIG. 10 is an enlarged illustration of the side view of FIG. 7.

FIG. 11 is a side view of the transportable spray system of FIG. 6 in an optional stowed configuration.

FIG. 12 is a top view of the transportable spray system of FIG. 6 in the optional stowed configuration.

### DETAILED DESCRIPTION OF PREFERRED EMBODIMENTS

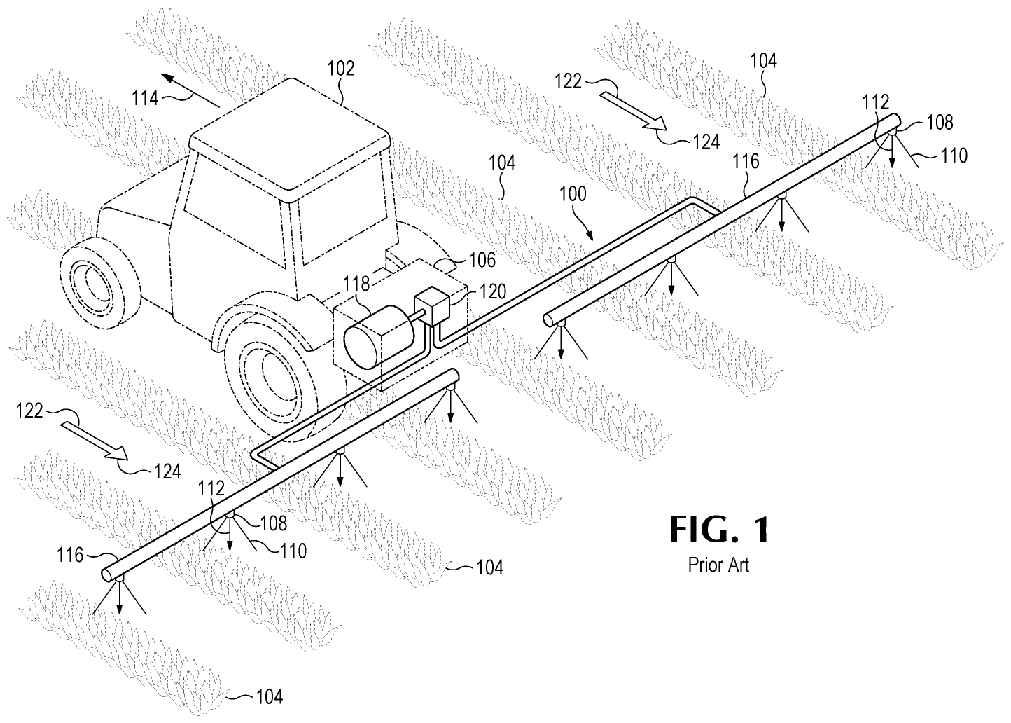

FIG. 1 is a schematic illustration of an example of a prior art transportable agricultural spray system 100 that may be carried on and/or transported by a vehicle 102 to spray one or more fluid (e.g., liquid) materials onto, for example, plants 104 or cropland. Vehicle 102 may include a tractor, a truck, or an all-terrain vehicle, or some other vehicle suited for use in an agricultural setting, for example. In some examples, plants 104 may include one or more crops or other cultivated plants, and the one or more fluid materials may include one or more agricultural supplements such as fertilizer, pesticide, fungicide, herbicide, or any other agricultural supplement. The one or more agricultural supplements may be in fluid or particulate solid form and may be carried or mixed in a fluid (e.g., liquid) carrier, such as water.

Transportable spray system 100 may include a transportable sprayer 106 and one or more spray nozzles 108 to emit one or more fluid sprays 110 in respective primary spray directions 112 while vehicle 102 transports spray system 100 in a transport direction 114. Spray nozzles 108 may be positioned along one or more elongate booms 116 (e.g., two shown) that may extend from vehicle 102 transverse to transport direction 114. Transportable sprayer 106 may include substantially any type of sprayer, including a conventional pneumatic sprayer or an electrostatic sprayer, which may include one or more fluid tanks 118 (e.g., one shown) and a fluid and/or a pneumatic pump 120 to generate fluid sprays 110, as is known in the art.

It will be appreciated that vehicle 102 passes through air in transport direction 114. Accordingly, while transported in transport direction 114, fluid sprays 110 may be subject at least to a transverse air flow 122 that may be generally in a second direction 124 that is transverse to primary spray directions 112 and may be generally opposite transport direction 114. In addition, environmental conditions, such as wind, may come from any direction relative to transport direction 114 and may contribute to transverse air flow 122 so that second direction 124 may not be directly opposite transport direction 114.

An aspect of fluid sprays 110 is that they may include numerous lightweight droplets and/or particulates that may be caused to deviate or drift from primary spray directions 112 by transverse air flow 122. Drift of fluid sprays 110 from primary spray directions 112 may decrease the efficiency and/or completeness with which fluid sprays 110 cover or are applied to plants 104. As a consequence, the effectiveness of fluid sprays 110 may be decreased, or increased amounts of fluid sprays 110 may need to be applied to compensate for decreased efficiency and/or completeness of coverage resulting from misdirection of fluid sprays 110 caused by transverse airflow 120.

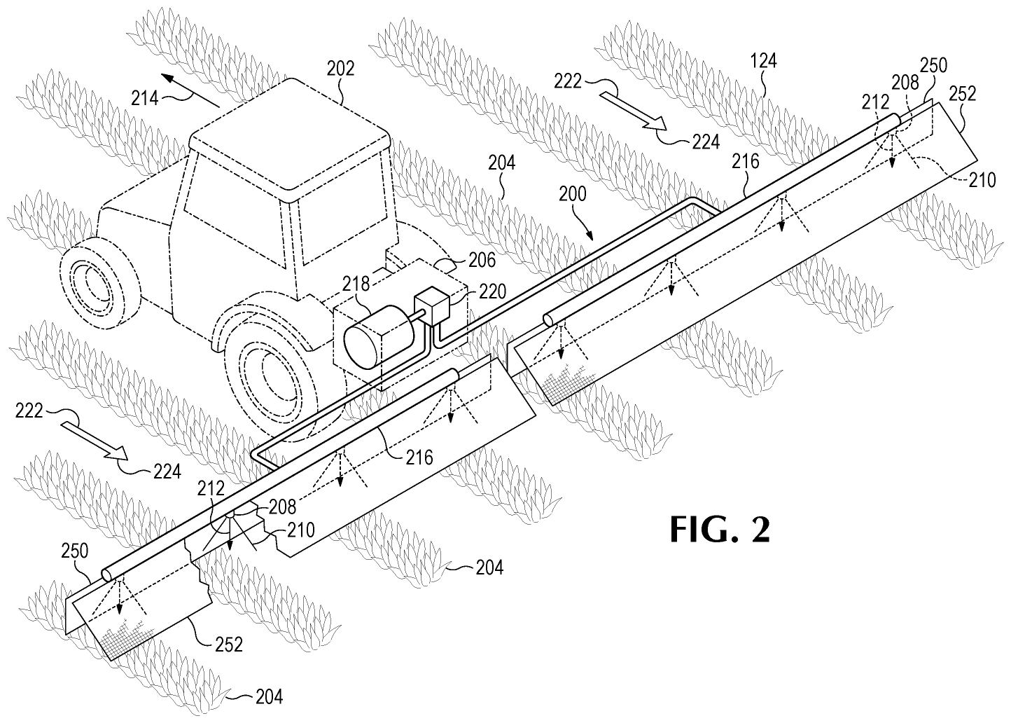

FIG. 2 is a schematic illustration of an example of a transportable spray system 200 that may be carried on and/or transported by a vehicle 202, or another carrier, to spray one or more fluid (e.g., liquid) materials onto, for example, plants 204 or cropland. Vehicle 202 may include a tractor, a truck, or an all-terrain vehicle, for example, or some other vehicle suited for use in an agricultural setting. In some examples, plants 204 may include one or more crops or other cultivated plants, and the one or more fluid materials may include one or more agricultural supplements such as fertilizer, pesticide, fungicide, herbicide, or any other agricultural supplement. The one or more agricultural supplements may be in fluid or particulate solid form and may be carried or mixed in a fluid (e.g., liquid) carrier, such as water.

Transportable spray system 200 may include a transportable sprayer 206 and one or more spray nozzles 208 to emit one or more fluid sprays 210 in respective primary spray directions 212 while vehicle 202 transports spray system 200 through air in a transport direction 214. Spray nozzles 208 may be positioned along one or more elongate booms 216 (e.g., two shown) that may extend from vehicle 202 transverse to transport direction 214. In the example of FIG. 2, two booms 216 are illustrated as extending substantially parallel to the ground in relation to a row or field crop. It will be appreciated, however, that transportable spray system 200 may include one or more booms 216, and the one or more booms 216 may extend substantially parallel to the ground, as illustrated, or may have any other orientation, including vertical, according to whether plants 204 are a row or field crop or are an orchard, vineyard, or some other sort of crop. In some examples, the one or more booms 216 may be oriented with respect to a high-density “fruiting wall” orchard configuration. Transportable sprayer 206 may include substantially any type of sprayer, including a conventional pneumatic sprayer or any electrostatic sprayer, such as an electrostatic sprayer as described in U.S. patent application Ser. No. 15/628,399, filed Jun. 20, 2017, which is hereby incorporated by reference. For example, transportable sprayer 206 may include at least one or more fluid tanks 218 (e.g., one shown) and a fluid and/or a pneumatic pump 220 to generate fluid sprays 210.

It will be appreciated that vehicle 202 with transportable spray system 200 passes through air in transport direction 214. While transported through air in transport direction 214, transportable spray system 200 may be subject at least to a transverse air flow 222 that may be generally in a second direction 224 that is transverse to primary spray directions 212 and may be generally opposite transport direction 214. In addition, environmental conditions, such as wind, may come from any direction relative to transport direction 214 and may contribute to transverse air flow 222 so that second direction 224 may not be directly opposite transport direction 214.

An aspect of fluid sprays 210 is that they include numerous lightweight droplets or particulates that could be susceptible to deviating or drifting from primary spray directions 212 by transverse air flow 222. To reduce and/or alleviate such deviating or drifting from primary spray directions 212, transportable spray system 200 may further include an air-permeable panel 250 positioned adjacent to and substantially outside fluid sprays 210 to extend over an area transverse to at least one of transport direction 214 and second direction 224 across the one or more fluid sprays 210. As illustrated in FIG. 2, air-permeable panel 250 may be positioned to extend over an area anterior to (e.g., in front of) fluid sprays 210 with respect to transport direction 214.

As further illustrated in FIG. 2, transportable spray system 200 may optionally include another air-permeable panel 252 that is also positioned adjacent to and substantially outside fluid sprays 210 to extend over an area transverse to at least one of transport direction 214 and second direction 224 across the one or more fluid sprays 210, wherein air-permeable panel 252 may be positioned to extend over an area posterior to (e.g., behind) fluid sprays 210 with respect to transport direction 214. In some examples and/or implementations, transportable spray system 200 may include both air-permeable panels or windscreens 250 and 252 positioned, respectively, anterior to and posterior to fluid sprays 210 with respect to transport direction 214. In other examples and/or implementations, transportable spray system 200 may include one or more air-permeable panels 250 positioned, anterior to fluid sprays 210 with respect to transport direction 214, but not air-permeable panels 252 positioned posterior to fluid sprays 210. In yet other examples and/or implementations, transportable spray system 200 may include air-permeable panels 252 positioned posterior to fluid sprays 210 with respect to transport direction 214, but not air-permeable panels 250 positioned anterior to fluid sprays 210.

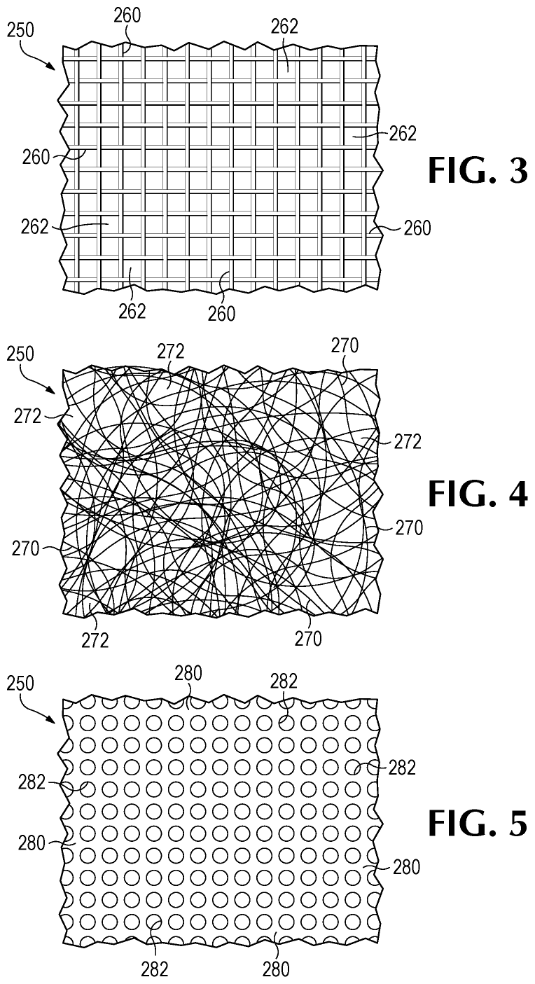

FIG. 3 is a partial front view of an example of air-permeable panel or windscreen 250, which may also be implemented as air-permeable panel 252. Air-permeable panel 250 may be characterized as having a solid surface area 260 and a plurality of openings 262 that permit and/or provide for permeability of air through panel 250. In the example of FIG. 3, air-permeable panel 250 may be formed of a woven arrangement of strands (e.g., a fabric) that may be or include fibrous, plastic, and/or metallic characteristics that form solid surface area 260 and may sometimes be referred to as a screen. As examples, the strands of the woven arrangement may include and/or be formed of stainless steel, aluminized or aluminum-coated plastic (e.g., polypropylene), and/or materials without metallic components.

In some examples, the relative portion of solid surface area 260 to the plurality of openings 262 may be generally uniform from a proximal edge that is adjacent boom 216 (FIG. 2) to a distal edge that is distal from boom 216. In other examples, the relative portion of solid surface area 260 to the plurality of openings 262 may vary from the proximal edge that is adjacent boom 216 (FIG. 2) to the distal edge that is distal from boom 216. For example, the relative portion of solid surface area 260 to the plurality of openings 262 may be greater near the proximal edge that is adjacent boom 216 (FIG. 2) and lesser near the distal edge that is distal from boom 216. In one example, the area adjacent the proximal edge may include few or no openings so that in some applications air flow contacting the area adjacent the proximal edge may be directed substantially or entirely over boom 216.

Air-permeable panel 250 and/or 252 may decrease the speed and/or intensity of transverse air flow 222 passing through and across fluid sprays 210 while reducing introduction of airflow turbulence or eddies that could be formed by an impermeable panel. Airflow turbulence or eddies that could be formed by an impermeable panel may cause fluid sprays 210 to deviate or drift from primary spray directions 212 in undesirable ways. In other examples, air-permeable panel 250 and/or 252 may decrease the deviation, drift, and/or misdirection of fluid sprays 210 that may arise from environmental winds, thermal conditions such as daily cyclic heating or thermal variations arising from localized heating differences such as may occur with ground inclination relative to incident sunlight, or volatilization of some fluid spray materials or components. As a result, air-permeable panel 250 and/or 252 may allow application of fluid sprays 210 over a wider range of environmental conditions with reduced deviation, drift, and/or misdirection of fluid sprays 210.

FIG. 4 is a partial front view of another example of air-permeable panel or windscreen 250, which may also be implemented as air-permeable panel 252. Air-permeable panel 250 may be characterized as having a solid surface area 270 and a plurality of openings 272 that permit and/or provide for permeability of air through panel 250. In the example of FIG. 4, air-permeable panel 250 may be formed of a spun or nonwoven arrangement of strands (e.g., a fabric), which may include fibrous, plastic, and/or metallic materials or characteristics that may be formed from staple (short) strands or long (continuous) strands, which may be bonded together by chemical, mechanical, heat and/or solvent treatment to form solid surface area 270. As examples, the strands of the spun or non-woven arrangement may include and/or be formed of stainless steel, aluminized or aluminum-coated plastic (e.g., polypropylene), and/or materials without metallic components.

In some examples, the relative portion of solid surface area 270 to the plurality of openings 272 may be generally uniform from a proximal edge that is adjacent boom 216 (FIG. 2) to a distal edge that is distal from boom 216. In other examples, the relative portion of solid surface area 270 to the plurality of openings 272 may vary from the proximal edge that is adjacent boom 216 (FIG. 2) to the distal edge that is distal from boom 216. For example, the relative portion of solid surface area 270 to the plurality of openings 272 may be greater near the proximal edge that is adjacent boom 216 (FIG. 2) and lesser near the distal edge that is distal from boom 216.

FIG. 5 is a partial front view of another example of air-permeable panel or windscreen 250, which may also be implemented as air-permeable panel 252. Air-permeable panel 250 may be characterized as having a solid, planar surface area 280 that includes a plurality of apertures or openings 282 that permit and/or provide for permeability of air through panel 250. In the example of FIG. 5, air-permeable panel 250 may be formed of a solid sheet or panel, which may be resiliently pliable and may include plastic or metallic materials or characteristics through which openings 282 may be formed, stamped, drilled, etc.

Some examples of air-permeable panel 250 and/or 252, such as illustrated in FIGS. 2-5, may include openings or open areas that may range between 10% and 90% in relation to solid areas that may range between 90% and 10%, respectively. In some particular examples, panel 250 may include openings or open areas that may range between 10% and 30% in relation to solid areas that may range between 90% and 70%, respectively, and panel 252 may include openings or open areas that may range between 40% and 60% in relation to solid areas that may range between 60% and 40%, respectively.

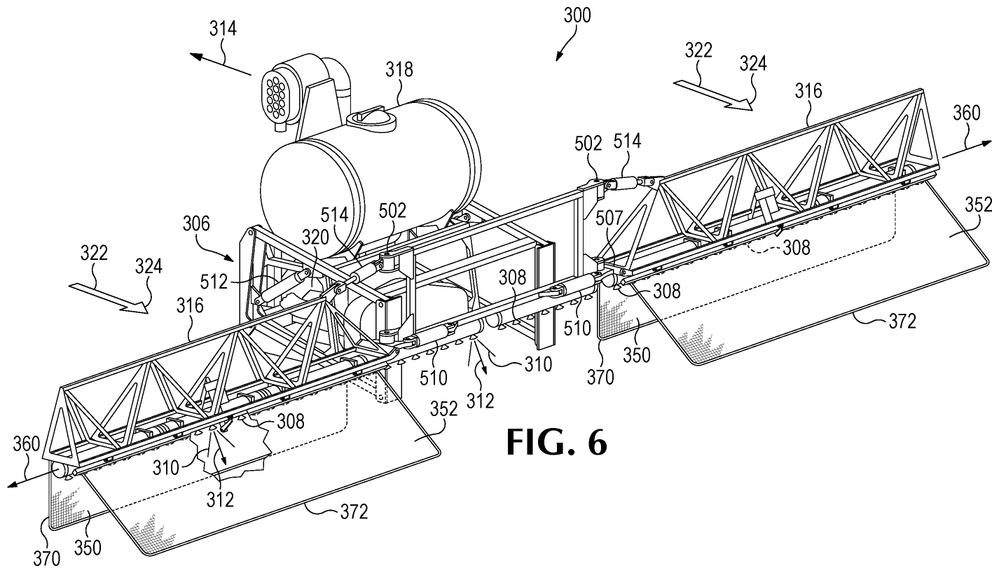

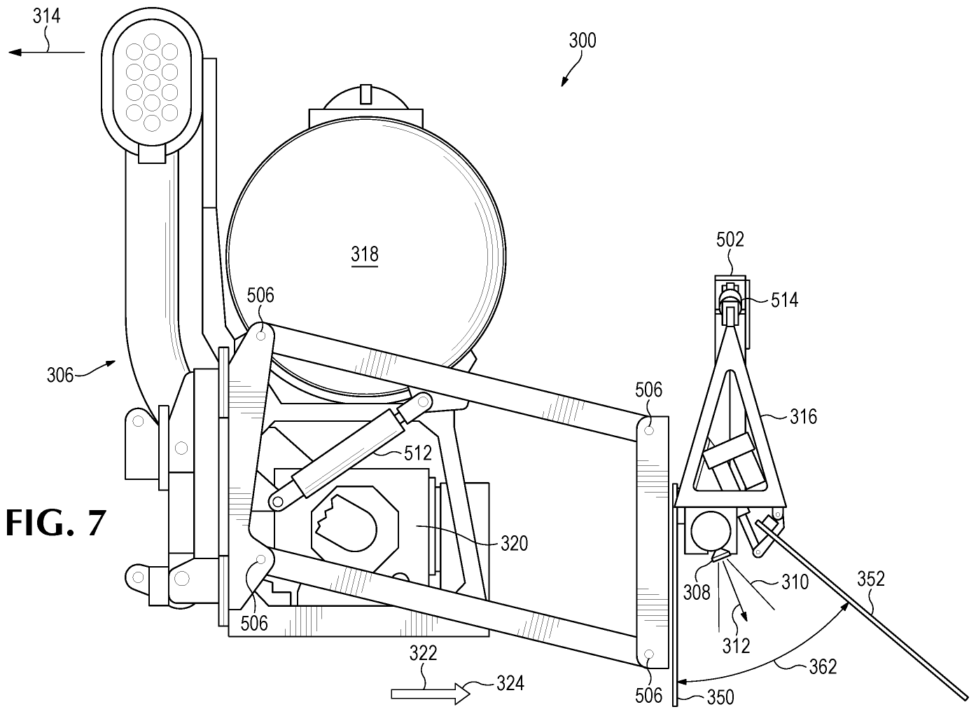

FIGS. 6 and 7 are respective rear elevation and side views of an example of a transportable spray system 300 that may analogous to transportable spray system 200 (FIG. 2) to be carried on and/or transported by a vehicle or another carrier (not shown) to spray one or more fluid (e.g., liquid) materials onto, for example, cultivated and/or agricultural plants or cropland. As with transportable spray system 200 (FIG. 2), the one or more fluid materials may include one or more agricultural supplements such as fertilizer, pesticide, fungicide, herbicide, or any other agricultural supplement. The one or more agricultural supplements may be in fluid or particulate solid form and may be carried or mixed in a fluid (e.g., liquid) carrier, such as water.

Transportable spray system 300 may include a transportable sprayer 306 and one or more spray nozzles 308 to emit one or more fluid sprays 310 in respective primary spray directions 312 while vehicle 302 transports spray system 300 through air in a transport direction 314. Spray nozzles 308 may be positioned along one or more elongate booms 316 (e.g., two shown) that may include a truss support structure and may extend from a vehicle transverse to transport direction 314. Transportable sprayer 306 may include substantially any type of sprayer, including a conventional pneumatic sprayer or any electrostatic sprayer, such as an electrostatic sprayer as described in U.S. patent application Ser. No. 15/628,399, filed Jun. 20, 2017. For example, transportable sprayer 306 may include at least one or more fluid tanks 318 (e.g., one shown) and a fluid and/or a pneumatic pump 320 to generate fluid sprays 310.

While transported through air in transport direction 314, transportable spray system 300 may be subject at least to a transverse air flow 322 that may be generally in a second direction 324 that is transverse to primary spray directions 312 and may be generally opposite transport direction 314. In addition, environmental conditions, such as wind, may come from any direction relative to transport direction 314 and may contribute to and/or modify transverse air flow 322 so that second direction 324 may not be directly opposite transport direction 314.

Transportable spray system 300 may further include air-permeable panels or windscreens 350 and 352 that are positioned adjacent to and substantially outside fluid sprays 310 to extend over an area transverse to at least one of transport direction 314 and second direction 324 across the one or more fluid sprays 310. As illustrated in FIGS. 6 and 7, air-permeable panel 350 may be positioned to extend over an area anterior to fluid sprays 310 with respect to transport direction 314, and air-permeable panel 352 may be positioned to extend over an area posterior to fluid sprays 310 with respect to transport direction 314. Air-permeable panels 350 and 352 may be analogous to any of air-permeable panels 250 and 252 described herein.

In some examples, at least one of air-permeable panels 350 and 352 (e.g., air-permeable panel 350) may have an orientation substantially parallel to primary spray directions 312 and/or substantially perpendicular to transport direction 314. For example, air-permeable panel 350 may have a fixed orientation substantially parallel to primary spray directions 312, which may be substantially vertical relative the ground on which plants 204 (FIG. 2) grow. In other examples, at least one of air-permeable panels 350 and 352 (e.g., air-permeable panel 352) may be not substantially parallel to primary spray directions 312, but rather tilted or inclined about an axis 360 that is substantially parallel to elongate booms 316. As a result, air-permeable panel 352 may have an orientation at an inclination angle 362 relative to the orientation of air-permeable panel 350. In some examples, inclination angle 362 may be between 0 degrees and 90 degrees relative to the orientation of air-permeable panel 350, and the inclination angle 362 may be fixed or may be variable. A tilted or inclined orientation of air-permeable panel 352 may cooperate with the orientation of air-permeable panel 350 being substantially parallel to primary spray directions 312 and/or substantially perpendicular to transport direction 314 to further reduce deviation or drifting of fluid sprays 310 from primary spray directions 312 that may be caused by transverse air flow 322.

Air-permeable panels 350 and 352 may be supported about their peripheries by respective frames 370 and 372 in particular, for example, with air-permeable panels 350 and 352 formed of fabric materials, as illustrated in FIGS. 3 and 4. Frames 370 and 372 may be formed of resilient, pliable materials, such as fiber-reinforced composites. Fiber-reinforced composites of frames 370 and/or 372 may include fiberglass, carbon, and/or aramid fibers that may be held in a matrix that may include resin, epoxy, or some other plastic, and may be held in place under tension. An aspect of resilient, pliable frames 370 and 372 is that they may allow air-permeable panels 350 and 352 that incidentally brush-over or contact plants or cropland to do so with reduced likelihood of damaging the plants and/or air-permeable panels 350 and 352.

In some examples, air-permeable panel 352 may have an orientation at a fixed inclination angle 362 relative to the orientation of air-permeable panel 350. In other examples, air-permeable panel 352 may have an orientation at an inclination angle 362 that may be varied relative to the orientation of air-permeable panel 350.

As described above, transportable sprayer 306 may include an electrostatic sprayer that may impart an electrostatic charge to fluid sprays 310 and/or their components. In some examples in which transportable sprayer 306 may include an electrostatic sprayer, one or both of air-permeable panels 350 and 352 may be formed of a material (e.g., including a metallic component) to which an electrical potential may be applied. In operation, an electrical potential may be applied to one or both of air-permeable panels 350 and 352 to further reduce or minimize deviation or drifting of fluid sprays. As one example, an electrostatic sprayer 306 may impart a electrostatic charge of one polarity (e.g., negative) to fluid sprays 310 and/or their components, and one or both of air-permeable panels 350 and 352 may have an applied electrical potential of the opposite polarity (e.g., positive) to repel fluid sprays 310 from air-permeable panels 350 and 352 to be directed toward the target plants and/or cropland. As another example, an electrostatic sprayer 306 may impart a electrostatic charge of one polarity (e.g., negative) to fluid sprays 310 and/or their components, and one or both of air-permeable panels 350 and 352 may have an applied electrical potential of the same polarity (e.g., negative) to attract fluid sprays 310 to prevent them from drifting beyond air-permeable panels 350 and 352. As yet another example, an electrostatic sprayer 306 may impart an electrostatic charge of one polarity (e.g., negative) to fluid sprays 310 and/or their components, and one or both of air-permeable panels 350 and 352 may set at a grounded or neutral electrical.

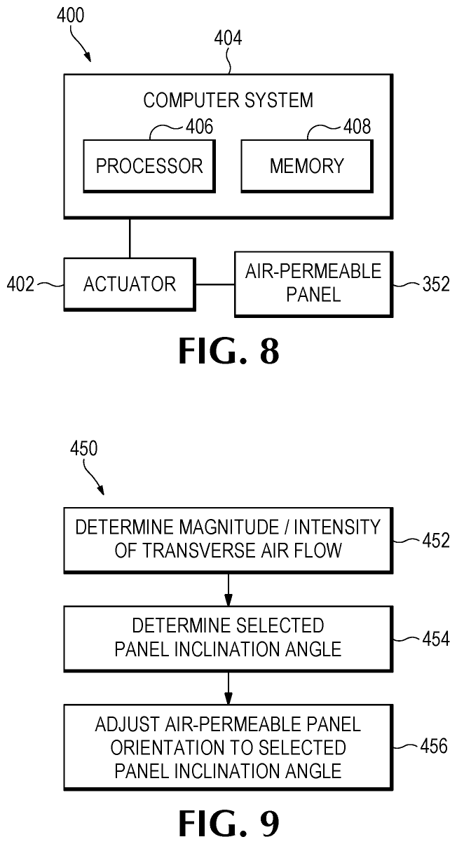

FIG. 8 is a block diagram of a panel orientation adjustment system 400 that may be included in transportable spray system 300 and may vary an orientation (e.g., inclination angle 362) of at least one of air-permeable panels or windscreens 350 and 352 (e.g., air-permeable panel 352). System 400 may include an actuator 402 (e.g., electric or hydraulic) coupled to pivot air-permeable panel 352 about a pivot rod or axle (not shown) that may extend along axis 360 (FIG. 6). Actuator 402 may be controlled by a computer system 404 that may include a processor 406 and computer-readable storage media or memory 408 to store software executable by processor 406. Software may refer to programs or routines (subroutines, objects, plug-ins, etc.), as well as data, usable by processor 406. Processor 406 and memory 408 may operate and/or communicate with each other, together with other conventional computer system components.

FIG. 9 is a flow diagram of a method 450 of varying an orientation of at least one of air-permeable panels or windscreens 350 and 352 (e.g., air-permeable panels 352) of transportable spray system 300, for example. Method 400 may be implemented by operation of panel orientation adjustment system 400, for example.

Operation 452 indicates that a magnitude and/or intensity of a transverse air flow may be determined. In some examples, the magnitude and/or intensity of the transverse air flow may be determined by an anemometer that may be carried by a vehicle that may also be carrying transportable spray system 300, for example. It will be appreciated that the magnitude and/or intensity of the transverse air flow may relate to a speed of the vehicle, as well as any other environmental conditions, such as wind. In some examples, determining the magnitude and/or intensity of the transverse air flow may also include determining a direction of the transverse air flow, such as with a wind vane that may be carried by a vehicle that may also be carrying transportable spray system 300. For example, winds may have a wind speed than may be significant relative to, or even greater than, than a vehicle speed of a vehicle that may be carrying transportable spray system 300. As a result, the transverse air flow may be in a direction other than a direction opposite the direction of vehicle motion. In some examples, such an anemometer may be in communication with computer system 404 to provide to it data relating to the magnitude and/or intensity of the transverse air flow.

Operation 454 indicates that a selected panel inclination angle may be determined with respect to the magnitude and/or intensity of a transverse air flow to reduce or minimize deviation or drifting of fluid sprays due to the transverse air flow. In some examples, a selected panel inclination angle may be stored in and obtained from memory 408 for each of a plurality of magnitudes and/or intensities of transverse air flow. In other examples, a selected panel inclination angle may be calculated by processor 406 the magnitude and/or intensity of the transverse air flow.

Operation 456 indicates that the orientation of at least one of air-permeable panels 350 and 352 (e.g., air-permeable panel 352) may be adjusted or set to the selected panel inclination angle, thereby to reduce or minimize deviation or drifting of fluid sprays due to the transverse air flow. In some examples, the orientation of air-permeable panel 352 may be imparted by operation of actuator 402 under control of computer system 404.

Method 450 describes automated varying of an orientation of at least one of air-permeable panels 350 and 352 (e.g., air-permeable panels 352). It will be appreciated, however, that panel orientation adjustment system 400 may also provide for operator selection and/or adjustment of panel orientation. For example, an operator may override or adjust automated varying of the orientation of at least one of air-permeable panels 350 and 352 (e.g., air-permeable panels 352). Such operator selection and/or adjustment of panel orientation may allow an operator to improve reduction of deviation or drifting of fluid sprays based on observation of conditions or praying effectiveness.

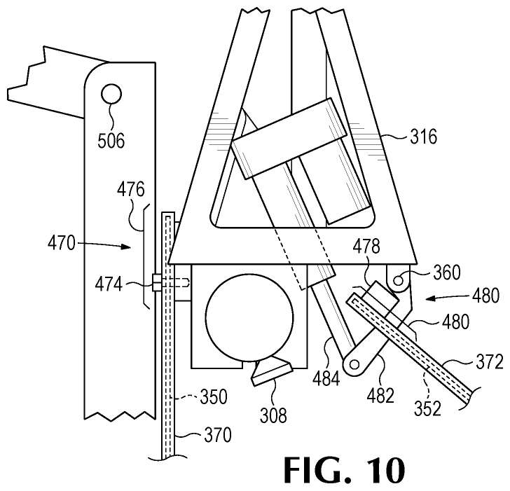

FIG. 10 is an enlarged illustration of the side view of FIG. 7 to indicate, as an example, a fixed boom coupling 470 to couple air-permeable panel 350 to boom 316 fixedly and a variable boom coupling 472 to couple air-permeable panel 352 to boom 316 with a variable orientation. Fixed boom coupling 470 may include multiple spaced attachments (e.g., bolts) 474 (one shown in outline) that may extend through and couple a boom-proximal portion 476 of frame 370 to boom 316. Variable boom coupling 472 may include a connector 478 that connects a boom-proximal portion 480 of frame 372 to a pivot arm 482 with one end that pivots about axis 360 (FIG. 6). An actuator 484 (e.g., hydraulic), analogous to actuator 402 referred to in FIG. 8, may be coupled to another end of pivot arm 482 to pivot and air-permeable panel 352 about axis 360.

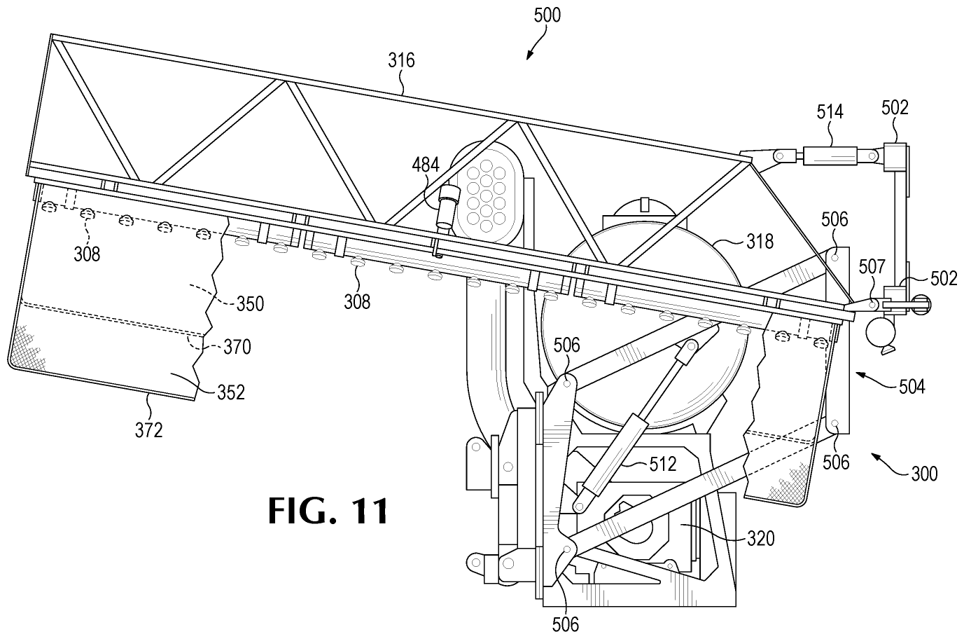

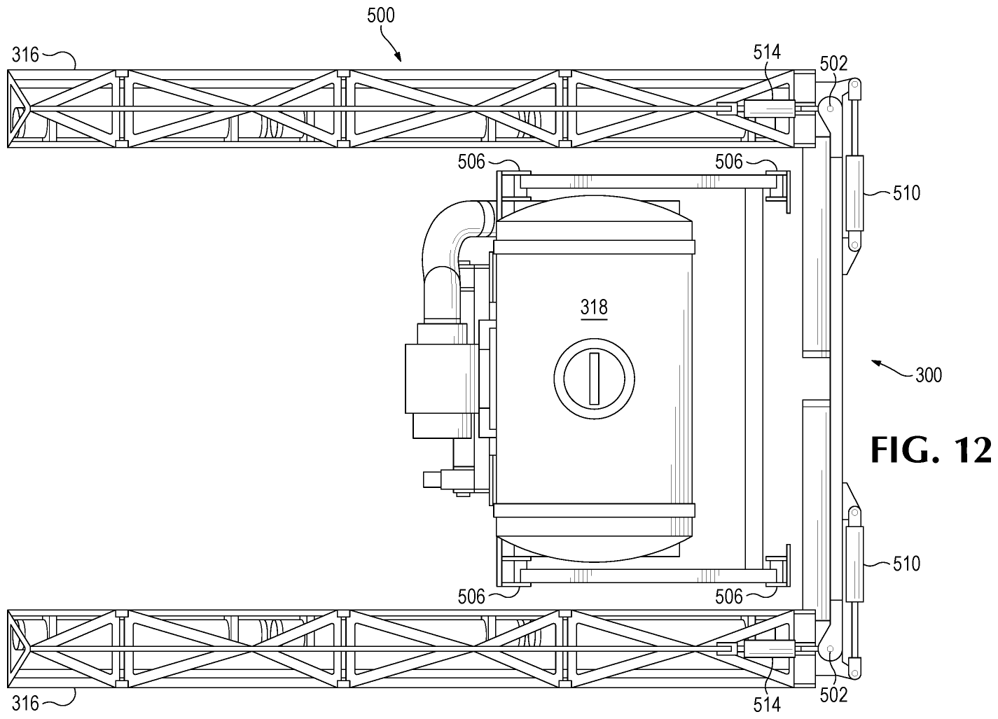

FIGS. 11 and 12 are respective side and top plan views of transportable spray system 300 in an optional stowed configuration 500, wherein booms 316 may be positioned generally perpendicular to their transverse alignment when being used. Stowed configuration 500 allows booms 316 and air-permeable panels 350 and 352 to be oriented along the sides of transportable spray system 300, rather than extending from the sides of transportable spray system 300. Stowed configuration 500 may reduce the area needed for storage of transportable spray system 300 and may also facilitate transporting transportable spray system 300 by reducing the transverse extend of booms 316 and also reducing the wind load that may be exerted against booms 316 and air-permeable panels 350 and 352, particularly if transported on roadways at highway speeds.

Each of booms 316 includes a pair of generally vertical-axis hinges 502 about which each boom 316 may pivot from its transverse orientation, when in operation, into stowed configuration 500. In addition, booms 316 may be carried on a pivotable frame 504 that may include a pair of parallelogram joints 506 that may lift booms 316 vertically. Horizontal-axis hinges 507 may also allow each boom 316 to be tilted upward. It will be appreciated that in operation, booms 316 may sometimes be positioned relatively low to the ground. Raising booms 316 vertically into stowed configuration 500 may facilitate transporting spray system 300 between agricultural locations by increasing the separation of booms 316 and air-permeable panels 350 and 352 from the ground and/or roadway.

In some examples, spray system 300 may be manually moved between stowed configuration 500 and operating configuration (e.g., FIG. 6) by an operator releasing and/or unlocking vertical-axis hinges 502, parallelogram joints 506, and horizontal-axis hinges 507, and manually positioning spray system 300 between stowed configuration 500 and the operating configuration, and re-locking vertical-axis hinges 502, parallelogram joints 506, and horizontal-axis hinges 507. In other examples, as illustrated in FIGS. 11 and 12, for example, spray system 300 may include hydraulic cylinders 510 that may pivot booms 316 about vertical-axis hinges 502, hydraulic cylinders 512 that may operate parallelogram joints 506, and hydraulic cylinders 514 that may pivot booms 316 about horizontal-axis hinges 507. Hydraulic cylinders 510, 512, and 514 may operate together or separately, under control of an operator to move spray system 300 between stowed configuration 500 and the operating configuration.

Transportable spray system 300 is described as being carried on a vehicle during operation. It will be appreciated that in some agricultural applications, such as large-scale greenhouses, for example, equipment such as transportable spray system 300 may be carried on tracks that may set in place overhead or on the ground. In some other examples, in which air-permeable panels 350 and 352 may be formed of fabric materials, frames 370 and 372 may be hinged and foldable so that panels 350 and 352 may be retracted and rolled adjacent to boom 316 to further facilitate transport between agricultural locations.

Having described and illustrated the principles of the invention in a preferred embodiment thereof, it should be apparent that the invention may be modified in arrangement and detail without departing from such principles. We claim all modifications and variations coming within the spirit and scope of the following claims.

1. A transportable spray system, comprising:
a transportable sprayer with one or more spray nozzles to emit one or more fluid sprays while transported through air in a first direction;
a first air-permeable panel positioned adjacent the transportable sprayer substantially outside the one or more fluid sprays to extend over an area transverse to the first direction across the one or more fluid sprays.

2. The transportable spray system of claim 1 in which the first air-permeable panel is positioned in the first direction in relation to the one or more fluid sprays.

3. The transportable spray system of claim 2 further comprising a second air-permeable panel positioned adjacent the transportable sprayer at least substantially outside the one or more fluid sprays to extend over and an area across the one or more fluid sprays transverse to the first direction, wherein the second air-permeable panel is positioned opposite the first direction in relation to the one or more fluid sprays.

4. The transportable spray system of claim 3 in which at least one of the first and second air-permeable panels is tiltable about an axis transverse to the first direction.

5. The transportable spray system of claim 3 in which the second air-permeable panels is tiltable about an axis transverse to the first direction.

6. The transportable spray system of claim 3 in which at least one of the first and second air-permeable panels has a fixed position in relation to the one or more fluid sprays.

7. The transportable spray system of claim 3 in which at least one of the first and second air-permeable panels includes a conductive material.

8. The transportable spray system of claim 1 in which the transportable sprayer and the first air-permeable panel are attached to and carried by a vehicle.

9. The transportable spray system of claim 1 in which the transportable sprayer and the first air-permeable panel are attached to and carried along a track.

10. The transportable spray system of claim 1 in which the first air-permeable panel is positioned opposite the first direction in relation to the one or more fluid sprays.

11. The transportable spray system of claim 1 in which the first air-permeable panel includes a woven arrangement of strands.

12. The transportable spray system of claim 1 in which the first air-permeable panel includes a nonwoven arrangement of strands.

13. The transportable spray system of claim 1 in which the first air-permeable panel includes solid panel with a plurality of apertures.

14. A spray system windscreen, comprising:
an air-permeable panel that includes a solid surface area and a plurality of openings that provide for permeability of air;
a frame to support the air-permeable panel; and
a boom coupling attachable to the frame to couple the spray system windscreen to a spray system boom.

15. The spray system windscreen of claim 14 in which the boom coupling couples the spray system windscreen to a spray system boom at a fixed orientation.

16. The spray system windscreen of claim 14 in which the boom coupling couples the spray system windscreen to a spray system boom at a variable orientation.

17. The spray system windscreen of claim 14 in which the air-permeable panel includes a woven arrangement of strands.

18. The spray system windscreen of claim 14 in which the air-permeable panel includes a nonwoven arrangement of strands.

19. The spray system windscreen of claim 14 in which the air-permeable panel includes solid panel with a plurality of apertures.

20. A transportable spray method, comprising:
transporting a sprayer with one or more spray nozzles to emit one or more fluid sprays through air in a first direction;
determining a magnitude of air flow across the one or more fluid sprays; and
adjusting in accordance with the magnitude of air flow an orientation of an air-permeable panel positioned adjacent the sprayer substantially outside the one or more fluid.
